(19) United States
(12) Patent Application Publication
(10) Pub. No.: US 2009/0033992 A1
(43) Pub. Date: Feb. 5, 2009

(54) PRINTING APPARATUS, PRINTING METHOD, AND PRINTING SYSTEM

(75) Inventors: Takashi Ogiwara, Mishima-shi (JP); Hiroshi Kawagoe, Yokohama-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/181,941

(22) Filed: Jul. 29, 2008

Related U.S. Application Data
(60) Provisional application No. 60/952,661, filed on Jul. 30, 2007.

(51) Int. Cl. G06F 3/12

(52) U.S. Cl. 358/1.15

(57) ABSTRACT

A printing apparatus includes a printing unit, a communication unit which receives a print job that requires user authentication, a RAM which stores the print job received by the communication unit, and a user interface which is operated to input authentication information with respect to the print job stored in the RAM. The apparatus includes a processor unit which detects a non-printable error that occurs in the printing unit during execution of the print job, sets treatment of the print job interrupted due to the error, performs the user authentication on the basis of the authentication information input by using the user interface for execution of the print job stored in the RAM, executes the print job when the user authentication is successful, and performs a process of subjecting the print job to the set treatment when the non-printable error is detected during the execution of the print job.

### CROSS-REFERENCE TO RELATED APPLICATIONS

This application claims the benefit of U.S. Provisional Application No. 60/952,661, filed Jul. 30, 2007.

### BACKGROUND OF THE INVENTION

1. Field of the Invention

The present invention relates to a printing apparatus, a printing method, and a printing system for executing a print job that requires user authentication.

2. Description of the Related Art

In recent years, the spread of computers is remarkable. The computers are used for managing business information in various companies. However, confidential information forming a part of the business information leaks from the computers. This is now a social problem. Therefore, there is an increasing interest in security functions for the computers. Most companies have established a network environment in which plural computers share a digital multifunction peripheral and a printer. In this case, it is more likely that confidential information is printed by the multifunction peripheral and the printer. A print of the confidential information is distributed to, for example, only participants in a meeting as a confidential document that is required to be treated carefully.

Conventionally, security for confidential documents output as prints from the multifunction peripheral and the printer as the prints is not sufficiently ensured. For example, if a user as an administrator of confidential information receives a telephone call right after a print request, collection of the confidential document is delayed. Moreover, if the user forgets that the user has made this print request, the confidential document is not collected. When the confidential document is left uncollected in the multifunction peripheral or the printer because of such reasons, it is likely that another user learns content of the confidential document, recognizes the content and carries away the confidential document, has no interest in the content and throws the confidential document into a garbage can, or collects the confidential document by mistake together with normal prints placed over the confidential document. Moreover, even if another user notices the confidential document mixed in the normal prints, it is likely that, since the confidential document is not a print of another user, the confidential document is thrown away in a place where another person visits and content of the confidential document is learnt by unexpected people outside a company of the user.

A technique for performing user authentication in printing a document is installed in a digital multifunction peripheral in these days. This technique is known as a “private print” function. With this private print function, the digital multifunction peripheral executes a print job only when a user who has made a print request can directly collect a print. The user selects the private print function on a computer side and transmits a print job set with an authentication password to the digital multifunction peripheral to thereby make a print request. Thereafter, the user moves to the front of the digital multifunction peripheral, further performs operation for inputting the authentication password, and causes the digital multifunction peripheral to start execution of the print job on condition that user authentication is successful. In this case, since the print is directly collected by the user who has made the print request, it is possible to prevent information leakage, i.e., prevent content of the print from being learned by an outsider.

In some case, after a print job for a confidential document, a private document, or the like is output to a print device in an ordinary print job processing manner, the user finds that the print device cannot directly execute this print job and is worried that, until execution of the print job, information is likely to leak. A technique for solving this problem has already been proposed (see, for example, JP-A-2005-346180). This technique is a technique for checking in advance a print device in which a non-printable error such as lack of consumables like sheets or toners has occurred and prohibiting transmission of a print job to the print device. However, if it is possible to use the private print function for performing user authentication described above, the technique disclosed in JP-A-2005-346180 is unnecessary as measures against information leakage.

The error check in the technique disclosed in JP-A-2005-346180 is performed before execution of a print job. However, for example, the error of the lack of consumables does not always occur before execution of a print job. The error of the lack of consumables rather often occurs during execution of a print job for printing a large number of prints and is highly likely to interrupt this print job. Even if the user who has made the print request in the private print function is present in front of the digital multifunction peripheral at the time of occurrence of the error of the lack of consumables, when reserve consumables usually prepared near the digital multifunction peripheral have been used up, the user needs to go to other floors or the like and find the consumables.

While it takes a lot of time for the user to procure the consumable and the user cannot return to the digital multifunction peripheral, if another user procures this consumable from somewhere and supplies the consumable to the digital multifunction peripheral, the print job is resumed and information leakage to another user occurs.

### BRIEF SUMMARY OF THE INVENTION

It is an object of the present invention to provide a printing apparatus, a printing method, and a printing system that can ensure higher security for confidential information.

According to a first aspect of the present invention, there is provided a printing apparatus which comprises a printing unit, a reception unit which receives a print job that requires user authentication, a memory unit which stores the print job received by the reception unit, a user interface which is operated to input authentication information with respect to the print job stored in the memory unit, and a control unit which detects a non-printable error that occurs in the printing unit during execution of the print job, sets treatment of the print job that has been interrupted due to the error, performs the user authentication on the basis of the authentication information input by using the user interface for execution of the print job stored in the memory unit, executes the print job when the user authentication is successful, and performs a process of subjecting the print job to the set treatment when the non-printable error is detected during the execution of the print job.

According to a second aspect of the present invention, there is provided a printing method which comprises receiving a print job that requires user authentication, storing the received print job in a memory unit, performing the user authentication on the basis of user authentication information input with respect to the print job stored in the memory unit by using a user interface, executing the print job when the user authentication is successful, detecting a non-printable error that occurs during execution of the print job stored in the memory unit, setting treatment of the print job that has been interrupted due to the error, and performing a process of subjecting the print job to the set treatment when the non-printable error is detected during the execution of the print job.

According to a third aspect of the present invention, there is provided a printing system which comprises a printing apparatus, and a print request apparatus which transmits a print job that requires user authentication to the printing apparatus via a communication line, wherein the printing apparatus includes a printing unit, a reception unit which receives the print job from the print request apparatus, a memory unit which stores the print job received by the reception unit, a user interface which is operated to input authentication information with respect to the print job stored in the memory unit, and a control unit which detects a non-printable error that occurs in the printing unit during execution of the print job, sets treatment of the print job that has been interrupted due to the error, performs the user authentication on the basis of the authentication information input by using the user interface for the execution of the print job stored in the memory, executes the print job when the user authentication is successful, and performs a process of subjecting the print job to the set treatment when the non-printable error is detected during the execution of the print job.

In the printing apparatus, the printing method, and the printing system, when a print disabling error that occurs in the printing unit during execution of a print job is detected, treatment of the print job that has been interrupted due to the error is set, and a process of subjecting the print job to the set treatment is performed. Therefore, it is possible to ensure higher security for confidential information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the configuration of a printing system according to an embodiment of the present invention;

FIG. 2 is a block diagram showing an example of the configuration of the digital multifunction peripheral shown in FIG. 1;

FIG. 3 is a diagram showing an example of the configuration of an operation panel shown in FIG. 2;

FIG. 4 is a flowchart schematically showing an operation of the digital multifunction peripheral shown in FIG. 2;

FIGS. 5A to 5C are flowcharts showing, more in detail, a private print process shown in FIG. 4;

FIG. 6 is a diagram showing an example of a selection screen for print jobs, displayed in the private print process shown in FIGS. 5A to 5C;

FIG. 7 is a diagram showing an example of a print start way selection screen displayed in the private print process shown in FIG. 4;

FIG. 8 is a diagram showing an example of a treatment setting screen for a print job, displayed in the private print process shown in FIG. 4;

FIG. 9 is a diagram showing an example of a protection setting screen for a standby-state print job, displayed in the private print process shown in FIG. 4;

FIG. 10 is a flowchart showing an operation of preliminary registration performed by the digital multifunction peripheral in a first modification of the printing system;

FIG. 11 is a diagram showing an example of a treatment setting screen for a print job, displayed in a treatment setting process shown in FIG. 10;

FIG. 12 is a flowchart showing an essential part of the private print process modified in association with the preliminary registration shown in FIG. 10;

FIG. 13 is a diagram showing a sequence of print setting for a printer driver made by a user on a computer side in a second modification of the printing system;

FIG. 14 is a diagram showing a print setting screen for use in the sequence of the print setting shown in FIG. 13; and

FIG. 15 is a flowchart showing a storage operation for a private print job which is received from a computer and in which setting information is incorporated using the print setting screen shown in FIG. 14.

### DETAILED DESCRIPTION OF THE INVENTION

A printing system according to an embodiment of the present invention will be described hereinafter, with reference to the accompanying drawings.

FIG. 1 schematically shows the configuration of the printing system. The printing system is, for example, a local area network (LAN) in which digital multifunction peripherals MFP and computers COM are connected to each other by a wire or wireless. In the printing system, driver software for the digital multifunction peripherals MFP is installed in the computers COM, and each of the digital multifunction peripherals MFP is shared by the computers COM. In an office, each of the computers COM manages various kinds of business information. When a print of the business information is necessary, the computer COM requests any one of the digital multifunction peripherals MFP to print the business information as a print job.

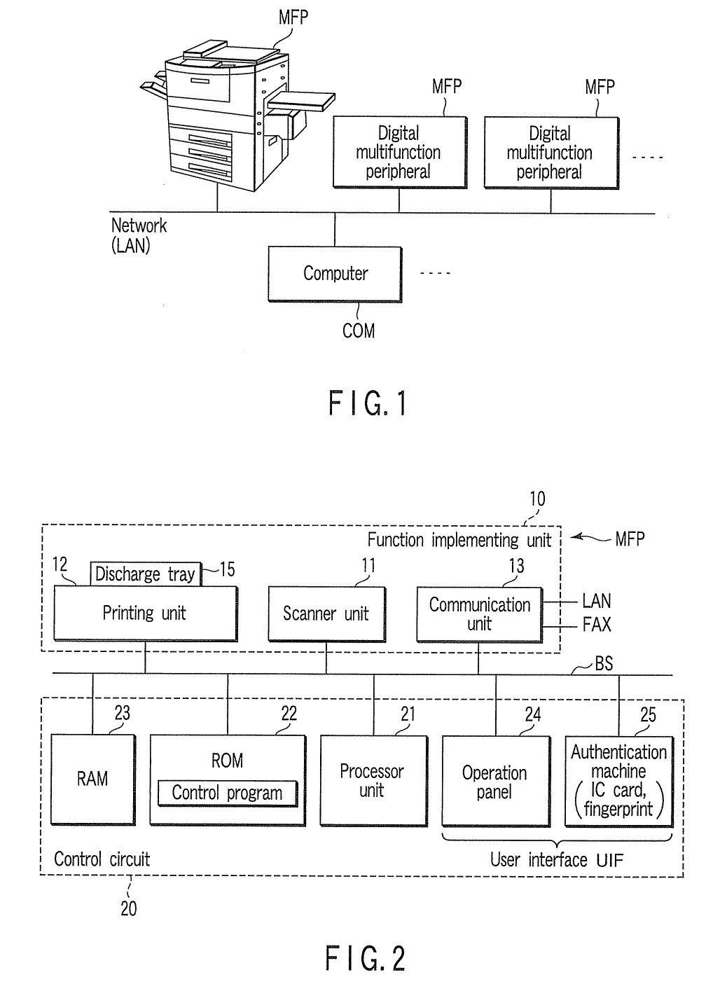

FIG. 2 shows an example of the configuration of the digital multifunction peripheral MFP shown in FIG. 1. The digital multifunction peripheral MFP includes a function implementing unit 10 which implements functions such as scanning, printing, and copying of an image, network (LAN) communication, and facsimile (FAX) communication, and a control circuit 20 which controls the function implementing unit 10.

The function implementing unit 10 includes, for example, a scanner unit 11 which reads an image of an original, a printing unit 12 which prints an image on a sheet, a communication unit 13 which performs LAN communication and FAX communication, and a discharge tray 15 on which a print output from the printing unit 12 is placed. The scanner unit 11 is provided in order to perform reading of original images for copying, FAX transmission, or computer editing, for example. The printing unit 12 is provided in order to perform electrophotographic printing of images such as an image scanned by the scanner unit 11, an image received as a facsimile by the communication unit 13, and an image corresponding to print data included in a print job from the computer COM connected to the communication unit 13 through a network. In the electrophotographic printing, the printing unit 12 forms an electrostatic latent image corresponding to image data on an image carrier, develops the electrostatic latent image as a toner image by selectively depositing a toner on the electrostatic latent image, and fixes the toner image on a sheet to obtain a print.

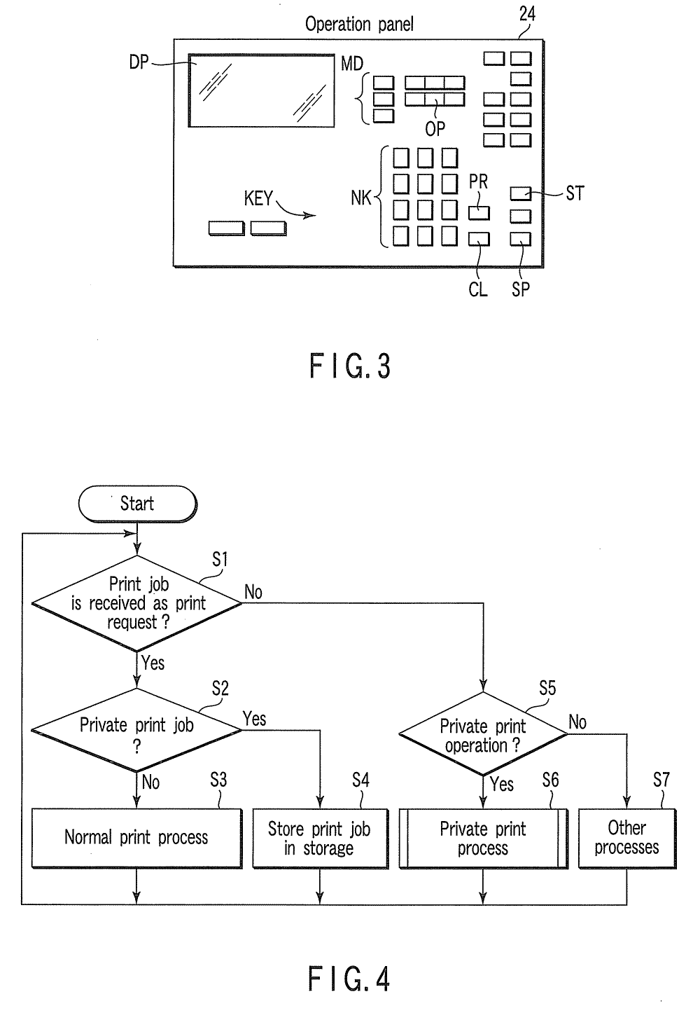

The control circuit 20 includes a processor unit 21 which controls the whole operation of the digital multifunction peripheral MFP, a ROM 22 which holds a control program of the processor unit 21, default setting data, and the like stored in advance, a RAM 23 which temporarily stores data input to and output from the processor unit 21, and an operation panel 24 which performs input operation and display of various data. In a part of the control program, an image processing program is provided in order to cause the processor unit 21 to perform image processing such as conversion of image data from a bitmap format into other file formats, conversion of print data from a PDL format into a print image (a raster image), resolution conversion, and correction. The operation panel 24 includes, for example, as shown in FIG. 3, operation keys KEY including menu selection keys MD, function option item selection keys OP, numerical value input keys NK, a clear key CL, a start key ST, a stop key SP, a private print key PR, and other keys and a touch panel type display DP capable of displaying pictures, messages, and the like along with various input keys, and accepting key-in operation of the input keys. An authentication machine 25 is provided as an option for user authentication performed by using an IC card or a fingerprint. The operation panel 24 and the authentication machine 25 serve as a user interface UIF. The scanner unit 11, the printing unit 12, the communication unit 13, the processor unit 21, the ROM 22, the RAM 23, the operation panel 24, and the authentication machine 25 are connected to one another by a control bus BS.

In the digital multifunction peripheral MFP, at least the components 13, 21, 22, and 23, UIF constitute a printing apparatus which manages a print job that requires user authentication as a private print function for the printing unit 15. In this management, the communication unit 13 receives the print job that requires user authentication from the computer COM. The RAM 23 serves as a storage that stores the print job received by the communication unit 13. The user interface UIF is operated by a user in order to input authentication information with respect to the print job stored in the RAM 23. The processor unit 21 performs the user authentication on the basis of the authentication information input by using the user interface UIF, controls the printing unit 15 to execute the print job when the user authentication is successful, detects a non-printable error that occurs in the printing unit 15 during the execution of the print job, requests, through the user interface UIF, the user to set treatment of the print job which has been interrupted due to the error, and performs a process of subjecting the print job to the treatment set to comply with the request by using the user interface UIF.

When the authentication machine 25 is not provided, the user selects the private print function on the computer side and transmits a print job set with an authentication password to the digital multifunction peripheral MFP to thereby issue a print request. Thereafter, the user moves to the front of the digital multifunction peripheral MFP, and operates the operation panel 24 of the digital multifunction peripheral MFP to input the authentication password. The digital multifunction peripheral MFP starts execution of the print job on condition that user authentication by password matching is successful.

On the other hand, when the authentication machine 25 is provided, reference authentication information is registered in the ROM 22 in advance. The user selects the private print function on the computer side and transmits a print job to the digital multifunction peripheral MFP to thereby issue a print request. Thereafter, the user moves to the front of the digital multifunction peripheral MFP, and operates the authentication machine 25 of the digital multifunction peripheral MFP to input authentication information obtained from an IC card or a fingerprint of the user. The multifunction peripheral MFP starts execution of the print job on condition that user authentication by collation of the authentication information and the reference authentication information is successful.

FIG. 4 schematically shows an operation of the digital multifunction peripheral MFP. When the operation of the digital multifunction peripheral MFP is started, in step S1, the processor unit 21 checks whether a print job is received as a print request from the computer COM. In step S2, the processor unit 21 checks whether the received print job is a private print job. When the received print job is not a private print job, in step S3, the processor unit 21 controls the printing unit 12 to perform a normal print process. On the other hand, when the received print job is a private print job, in step S4, the processor unit 21 stores the print job in the RAM 23 serving as the storage.

When a print job is not received in step S1, in step S5, the processor unit 21 checks whether the private print key PR is operated by the user as private print operation. When the private print operation has been carried out, in step S6, the processor unit 21 performs a private print process. When the private print operation has not been carried out, in step S7, the processor unit 21 performs other processes. Step S1 is executed again following the execution of steps S3, S4, S6, and S7.

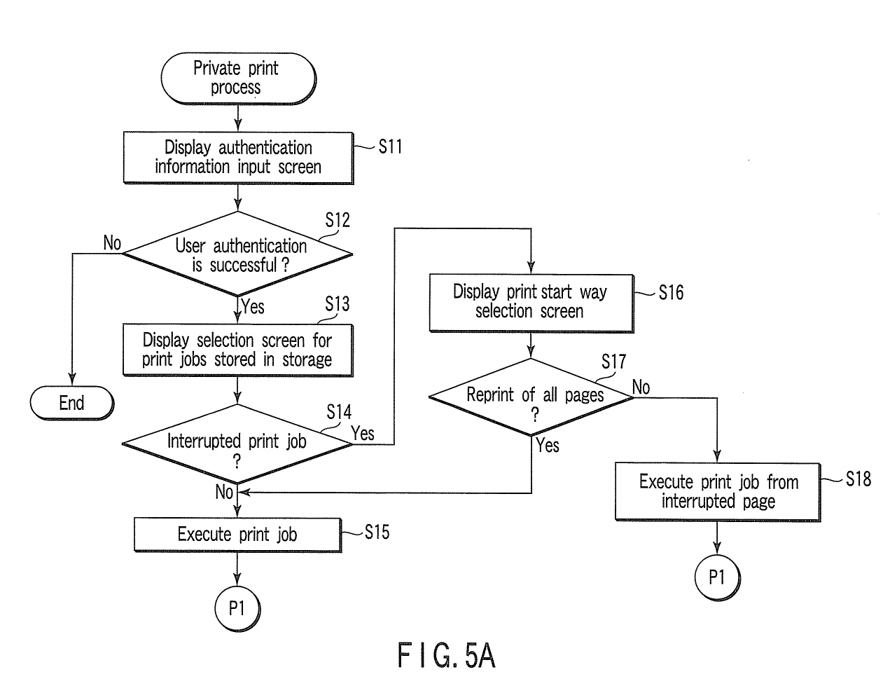

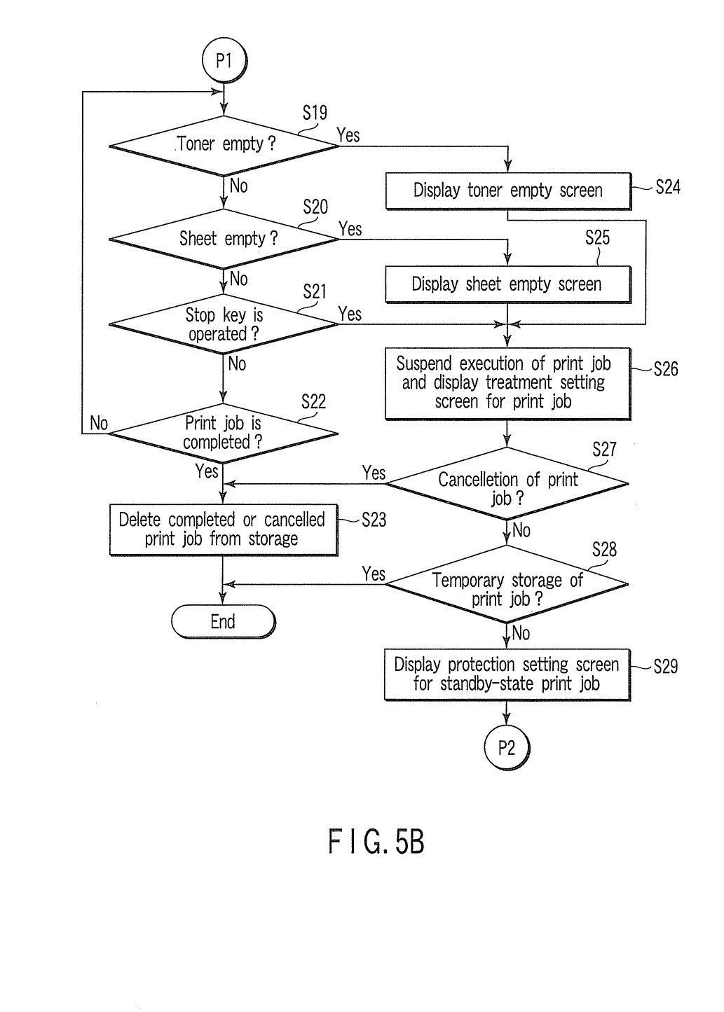

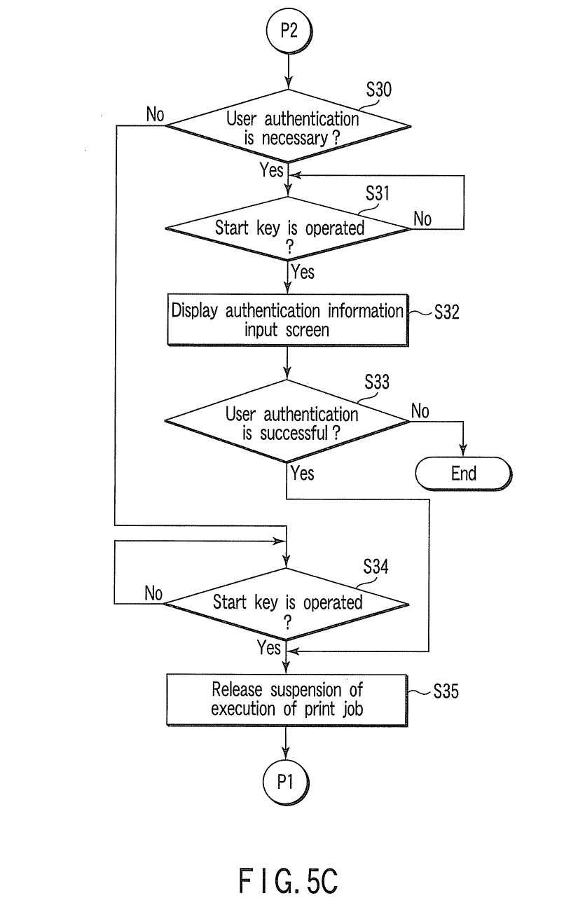

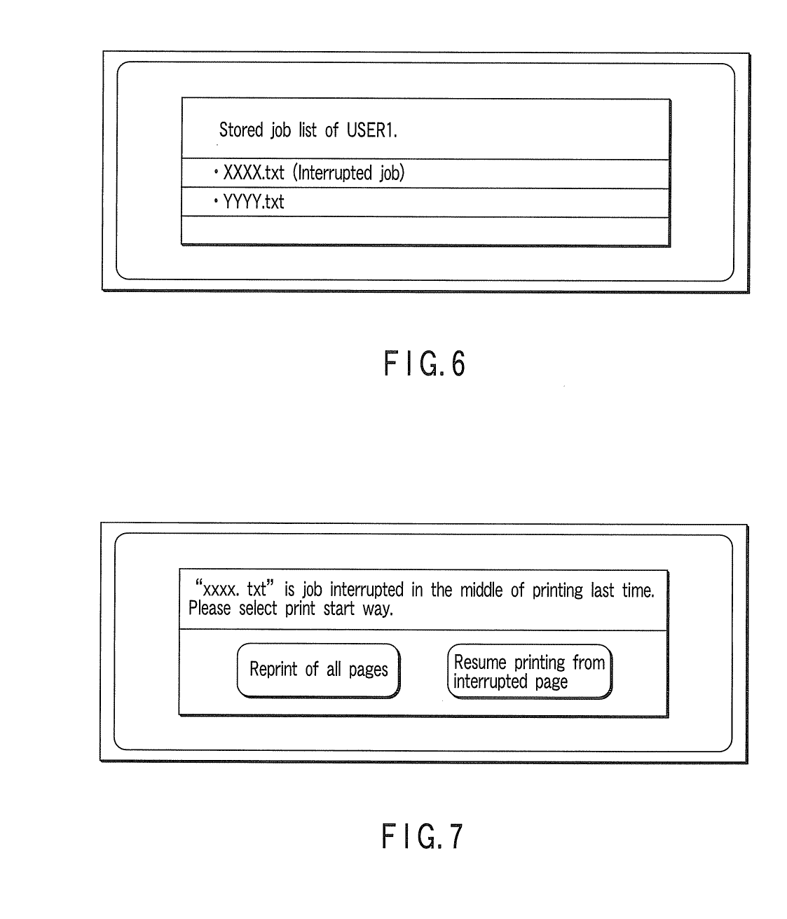

FIGS. 5A to 5C show more in detail the private print process shown in FIG. 4. When the private print process is started, in step S11, the processor unit 21 causes the display DP to display an authentication information input screen. The user inputs authentication information on the authentication information input screen. In the following explanation, it is assumed that the authentication information is a password. The user inputs the password from the operation panel 24 using input keys displayed as, for example, a keyboard in a part of the authentication information input screen or the numerical value input keys NK. In step S12, the processor unit 21 collates the password input from the operation panel 24 with a password which is set as reference authentication information by the user on the computer COM side upon selection of the private function and added to the print job. When the passwords match, the processor unit 21 determines that user authentication is successful. Even if the passwords mismatch, re-input of passwords is allowed three times. Failure in the user authentication is decided when a password input for the fourth time mismatches the password added to the print job. When the user authentication fails, the private print process is finished. When the user authentication is successful, in step S13, the processor unit 21 causes the display DP to display a selection screen for print jobs stored in the storage for the authenticated user. FIG. 6 shows an example of the selection screen for print jobs. When the user selects a desired print job from a print job list included in the screen, in step S14, the processor unit 21 checks whether the selected print job is an interrupted print job. When the selected print job is a new print job, in step S15, the processor unit 21 controls the printing unit 12 to execute the selected print job.

When it is confirmed in step S14 that the selected job is the interrupted print job, in step S16, the processor unit 21 causes the display DP to display a print start way selection screen. FIG. 7 shows an example of the print start way selection screen. On this screen, one of “Reprint of all pages” and “Resume printing from interrupted page” is selectable. In step S17, the processor unit 21 checks whether the user selects “Reprint of all pages”. When the selection of “Reprint of all pages” is confirmed, in step S15, the processor unit 21 controls the printing unit 12 to execute the print job. When the selection of “Resume printing from interrupted page” is confirmed, in step S18, the processor unit 21 controls the printing unit 12 to execute the print job from the interrupted page. In the execution of the print job, single-sided printing is started from the top of the interrupted page and double-sided printing is started from the top of a front side of the interrupted page. Setting of a print resumption position of such double-sided printing is performed in order to prevent printing of a front side from being omitted in resumption of printing interrupted on a rear side.

After the start of the execution of the print job, in step S19, the processor unit 21 checks whether toner empty occurs in the printing unit 12. In step S20, the processor unit 21 checks whether sheet empty occurs in the printing unit 12. In step S21, the processor unit 21 checks whether the stop key SP is operated. In step S22, the processor unit 21 checks whether the print job is completed. When the occurrence of toner empty is confirmed in step S19, in step S24, the processor unit 21 causes the display DP to display a toner empty screen for notifying the toner empty. Subsequently, in step S26, the processor unit 21 suspends the execution of the print job and causes the display DP to further display a treatment setting screen for the print job. When the occurrence of sheet empty is confirmed in step S20, in step S25, the processor unit 21 causes the display DP to display a sheet empty screen for notifying the sheet empty. Subsequently, in step S26, the processor unit 21 suspends the execution of the print job and causes the display DP to further display the treatment setting screen for the print job. When the operation of the stop key SP is confirmed in step S21, in step S26, the processor unit 21 suspends the execution of the print job and causes the display DP to further display the treatment setting screen for the print job. When it is confirmed in step S22 that the print job is not completed, the processor unit 21 repeatedly executes steps S19 to S20.

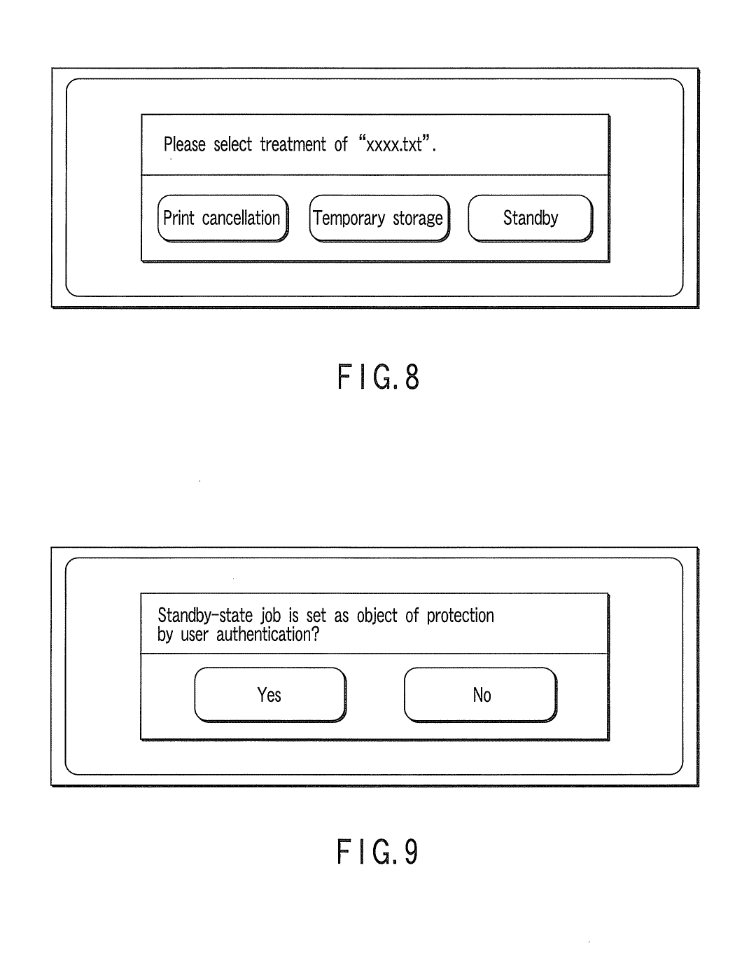

FIG. 8 shows an example of the treatment setting screen for the print job. On this setting screen, any one of “Print cancellation”, “Temporary storage”, and “Standby” is selectable. “Print cancellation” is used, for example, when it is unnecessary to print a printed matter required by the user to a last page because most of the printed matter has already been printed. “Temporary storage” is used when, although the user wants to continue printing, the user has to leave the digital multifunction peripheral MFP because reserve toners or sheets prepared near the digital multifunction peripheral MFP have been used up or when the user does not have enough time to supply toners or sheets. In these cases, although a print request from the computer COM side is unnecessary, the user needs to operate the private print key PR for execution of the private print process again.

“Standby” is used when reserve toners or sheets are available and prepared near the digital multifunction peripheral MFP, when the user can quickly return to the digital multifunction peripheral MFP even if the user leaves there in order to procure reserve toners or sheets, or when sufficient time is obtainable by prohibiting other users' print jobs.

In step S27, the processor unit 21 checks whether the selection of “Print cancellation” is performed in order to cancel the print job. When the completion of the print job is confirmed in step S22 or when the cancellation of the print job is confirmed in step S27, in step S23, the processor unit 21 deletes the print job from the storage and finishes the private print process. When it is confirmed in step S27 that the print job is not cancelled, in step S28, the processor unit 21 checks whether the selection of “Temporary storage” is performed to bring the print job into a hold state that requires further operation of the private key PR. When it is confirmed in step S28 that the print job is brought into the hold state, the processor unit 21 finishes the private print process without deleting the print job from the storage. When it is confirmed in step S28 that the print job is not brought into the hold state, the processor unit 21 regards this as selection of “Standby”. In step S29, the processor unit 21 causes the display DP to display a protection setting screen for the standby-state print job. When there is the job on standby, since the private print process is continued, other print jobs are not executed.

FIG. 9 shows an example of the protection setting screen for the standby-state print job. In this protection setting screen, one of “Yes” and “No” is selectable. When “Yes” is selected, a setting indicating that user authentication is necessary is performed. On the other hand, when “No” is selected, a setting indicating that the user authentication is unnecessary is performed. In a case where a “Standby” state is established upon interruption of the print job, it is expected that the print job is resumed immediately after supply of toners or sheets. However, if “Yes” is selected in this state, user authentication is necessary at the time of resuming the print job. Therefore, it is possible to ensure higher security even if the user takes a lot of time to procure reserve toners or sheets and cannot return quickly. In step S30, the processor unit 21 checks whether the user authentication is necessary. When the user authentication is necessary, in step S31, the processor unit 21 repeatedly checks operation of the start key ST. When the user authentication is unnecessary, in step S34, the processor unit 21 repeatedly checks operation of the start key ST. In both the cases, the start key ST is operated to resume the print job in a state where the reason for keeping the print job being interrupted is disappeared upon supply of toners or sheets.

When the operation of the start key ST is confirmed in step S31, in step S32, the processor unit 21 causes the display DP to display the authentication information input screen. The user inputs authentication information, i.e., a password on the authentication information input screen. As in the case of step S11, the user inputs the password from the operation panel 24 using the numerical value input keys NK or the input keys displayed as a keyboard in a part of the authentication information input screen. In step S33, the processor unit 21 collates the password input from the operation panel 24 with a password which is set by the user on the computer COM side upon selection of the private function and added to the print job. When the passwords match, the processor unit 21 determines that user authentication is successful. Even if the passwords mismatch, re-input of passwords is accepted three times. Failure in the user authentication is decided when a password input for the fourth time mismatches the password added to the print job. When the user authentication fails, the private print process is finished. When the user authentication is successful, in step S35, the processor unit 21 releases the suspension of the execution of the print job and returns to step S19. When the operation of the start key ST is confirmed in step S31, as in the above case, in step S35, the processor unit 21 releases the suspension of the execution of the print job and returns to step S19. Consequently, the execution of the print job is resumed and, in the same manner as step S18, the printing is resumed from the interrupted page.

According to this embodiment, when a non-printable error such as toner empty or sheet empty that occurs in the printing unit 12 during execution of a print job is detected, setting of treatment of the print job that has been interrupted due to the error is requested, and a process of subjecting the print job to the treatment set to comply with the request is performed. Therefore, it is possible to ensure higher security for confidential information.

In the embodiment, a password is input as authentication information. However, a fingerprint or an IC card for user identification may be read by the authentication machine 25. A combination of at least two of the password, the IC card, and the fingerprint can be used for user authentication.

In the digital multifunction peripheral MFP, a print job that requires user authentication is stored in the storage even when user authentication for the print job fails. However, in such a case, the processor unit 21 may delete the print job from the storage.

Moreover, in the digital multifunction peripheral MFP, toner empty and sheet empty are detected as a non-printable error. However, it is preferable that lack of consumables other than toners and sheets such as deterioration of an image carrier is detected as a non-printable error.

Furthermore, on the treatment setting screen for the interrupted print job, one of “Print cancellation”, “Temporary storage”, and “Standby” is selectable. However, the processor unit 21 may be configured to transfer the interrupted print job to the other digital multifunction peripherals MFP present on the network.

In the embodiment described above, “Standby” is selectable on the treatment setting screen for the interrupted print job. However, the selection key of “Standby” may be eliminated if the configuration is changed to start a timer (not shown) upon occurrence of the toner or sheet empty and automatically set the standby state after a preset time has been elapsed without selection of “Print cancellation” or “Temporary storage”.

In the present embodiment, occurrence of a sheet jam or a power cut is also regarded as a factor that interrupts the print job.

Further, in the embodiment described above, an operation of the start key ST is required to resume the print job from the standby state. The print job may be automatically resumed upon supply of toners or sheets. In addition, a screen for inputting authentication information may be displayed in accordance with an action of supplying toners or sheets in a case where necessity of user authentication has been set by the selection of “Yes” on the protection setting screen.

Next, a first modification of the printing system will be described below. This printing system has the same hardware configuration as that of the printing system shown in FIGS. 1 and 2. The control program of the processor unit 21 in the embodiment described above is configured such that the treatment setting screen is displayed for the interrupted print job each time toner or sheet empty occurs, and prompts the user to select one of “Print cancellation”, “Temporary storage”, and “Standby”. In contrast to this, the control program of the processor unit 21 in the first modification is configured to preliminarily register setting of treatment of the print job as initial setting information in the digital multifunction peripheral MFP.

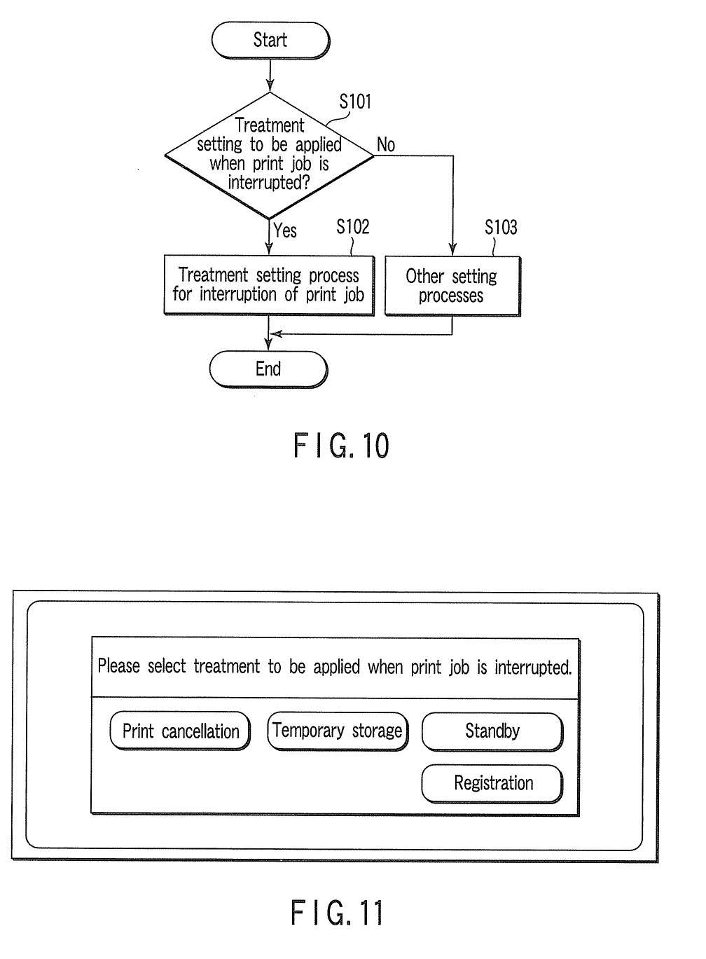

FIG. 10 schematically shows an operation of preliminary registration performed by the digital multifunction peripheral MFP in the first modification of the printing system. This preliminary registration operation is performed when a serviceman mode is established by an operation (not shown) of the digital multifunction peripheral MFP in step S7 shown in FIG. 4, for example. In step S101, the processor unit 21 checks whether there is a request for a mode of treatment setting to be applied when interruption of a print job occurs upon detection of an error of toner empty or sheet empty. When it is confirmed that the treatment setting mode is requested, the processor unit 21 performs a treatment setting process in step S102. In this treatment setting process of step S102, a setting screen is displayed on the display DP of the digital multifunction peripheral MFP and prompts the user to select one of “Print cancellation”, “Temporary storage”, and “Standby” as shown in FIG. 11. The treatment selected by the user is stored in the RAM 23 as the initial setting information when a registration key is depressed. If it is confirmed in step S101 that the treatment setting mode for interruption of a print job is not requested, other setting processes are performed in step S103. Thereafter, the serviceman mode is ended.

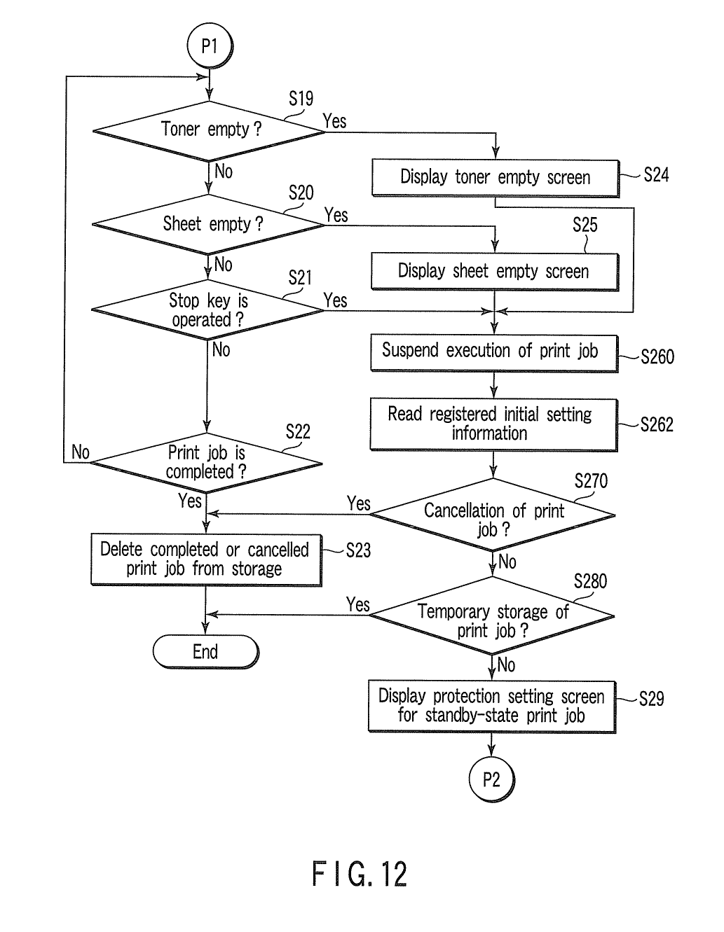

FIG. 12 shows an essential part of the private print process modified in association with the preliminary registration shown in FIG. 10. This private print process is identical to the private print process in the aforementioned embodiment, except that parts of the steps in FIG. 5B are changed as shown in FIG. 12. In FIG. 12, steps S260 and S262 are substituted for steps S26 shown in FIG. 5B, and steps S270 and S280 are substituted for steps S27 and S28 shown in FIG. 5B.

Execution of a print job starts in step S15 shown in FIG. 5A. Thereafter, when toner empty is detected in step S19 or sheet empty is detected in step S20, the processor unit 21 causes a toner empty screen to be displayed in step S24 or a sheet empty screen to be displayed in step S25, and suspends the execution of the print job. In step S262, the initial setting information, which is a selected one of “Print cancellation”, “Temporary storage”, and “Standby” and registered in the serviceman mode as treatment setting for interruption of the print job, is read from the RAM 23. Then, the processor unit 21 checks in step S270 whether the initial setting information is “Print cancellation”. When the completion of the print job is confirmed in step S22 or when the cancellation of the print job is confirmed in step S270, the processor unit 21 deletes the print job in step S23 from the storage and finishes the private print process. When it is confirmed in step S270 that the print job is not cancelled, the processor unit 21 checks in step S280 whether the selection of “Temporary storage” is performed to bring the print job into a hold state that requires further operation of the private key PR. When it is confirmed in step S280 that the print job is brought into the hold state, the processor unit 21 finishes the private print process without deleting the print job from the storage. When it is confirmed in step S280 that the print job is not brought into the hold state, the processor unit 21 regards this as selection of “Standby”. In step S29, the processor unit 21 causes the display DP to display a protection setting screen for the standby-state print job. The processes subsequent to step S29 are performed as described in the above embodiment.

According to the first modification, treatment setting for interruption of a print job is preliminarily registered in the digital multifunction peripheral MFP as a result of selection. Thus, the user does not need to carry out setting for each interruption.

Although, in the first modification, the display DP of the digital multifunction peripheral MFP is used to register treatment setting for interruption of a print job, the treatment setting may be registered as setting information obtained on a side of the computer COM connected on the network (LAN) and transmitted to the digital multifunction peripheral MFP. Further, the setting information may be registered from a web page which is presented on the computer COM using a web service function provided to the digital multifunction peripheral MFP.

Next, a second modification of the printing system is described below. This printing system has the same hardware configuration as that of the printing system shown in FIGS. 1 and 2. The control program of the processor unit 21 in the first modification is configured such that treatment setting for interruption of a print job is preliminarily registered in the digital multifunction peripheral MFP as initial setting information which is a selected one of “Print cancellation”, “Temporary storage”, and “Standby”. In contrast to this, the control program of the processor unit 21 in the second modification is configured to extract setting information which is one of “Print cancellation”, “Temporary storage”, and “Standby” selected as treatment setting for interruption of a print job and incorporated in the print job in the computer COM connected on the network (LAN), and to register the extracted setting information in the digital multifunction peripheral MFP.

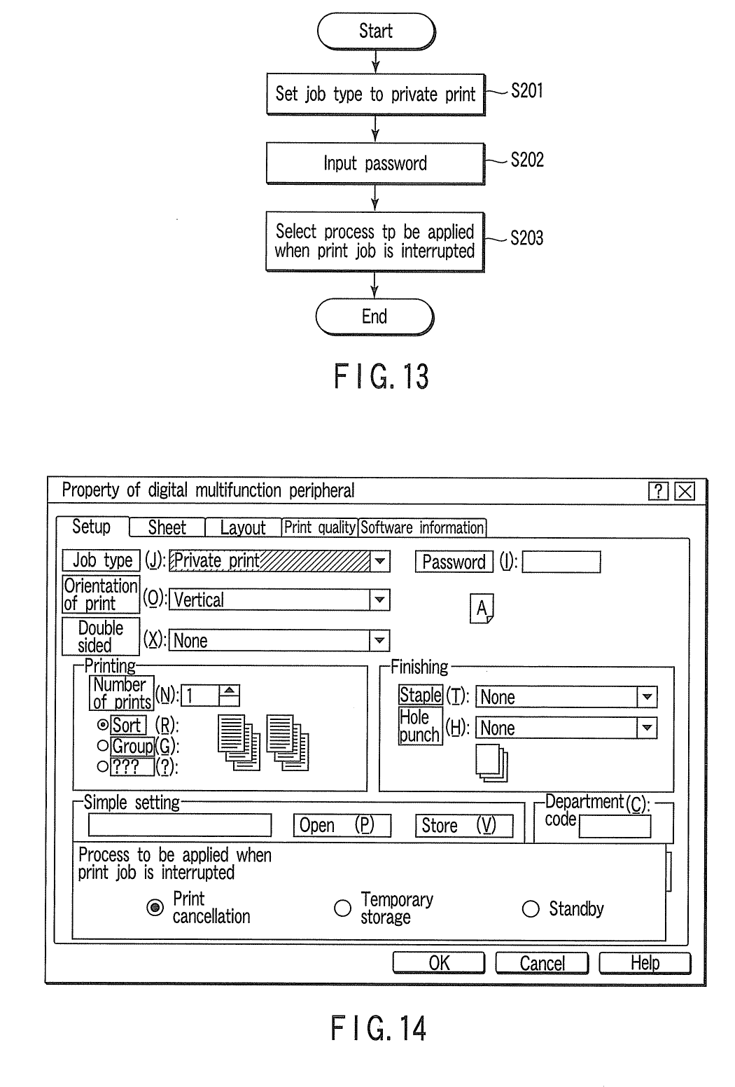

FIG. 13 shows a sequence of print setting for a printer driver made by the user on the computer COM side in the second modification. FIG. 14 shows a print setting screen for use in the sequence of the print setting shown in FIG. 13. The user selects “Private print” as a job type in step S201, inputs “Password” in step S202, and then selects one of “Print cancellation”, “Temporary storage”, and “Standby” displayed in an area of “Process to be applied when print job is interrupted” present within the print setting screen, as treatment setting for interruption of a print job.

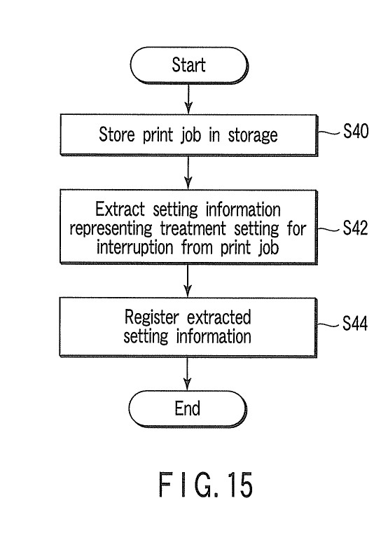

FIG. 15 shows a storage operation for a private print job which is received from the computer COM and in which setting information is incorporated using the print setting screen shown in FIG. 14. This operation is performed in step S4 shown in FIG. 1, for example. First, in step S40, the processor unit 21 stores the print job in the RAM 32. In step S42, the processor unit 21 extracts, from the print job stored in the RAM 23, setting information which is set to one of “Print cancellation”, “Temporary storage”, and “Standby” by the printer driver, in connection with treatment setting to be applied when the print job is interrupted. The, in step 44, the processor unit 21 registers setting information in the RAM 23 in order to perform the treatment of “Print cancellation”, “Temporary storage”, or “Standby” upon interruption of the print job.

Even if the treatment setting is set by the printer driver of the computer COM as a process to be applied when the print job is interrupted, the private print process is identical to that of the first modification, which has been explained with reference to FIG. 12. Therefore, detailed description thereof is omitted. In this modification, the treatment setting of “Print cancellation”, “Temporary storage”, or “Standby” is read from the RAM 23 in the same manner as the first modification to specify a process to be applied when the print job is interrupted.

According to the second modification, treatment setting for interruption of a print job is made concurrently with a print request. Thus, the user does not need to carry out the setting at the digital multifunction peripheral MFP.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A printing apparatus comprising:
a printing unit;
a reception unit which receives a print job that requires user authentication;
a memory unit which stores the print job received by the reception unit;
a user interface which is operated to input authentication information with respect to the print job stored in the memory unit; and
a control unit which detects a non-printable error that occurs in the printing unit during execution of the print job, sets treatment of the print job that has been interrupted due to the error, performs the user authentication on the basis of the authentication information input by using the user interface for execution of the print job stored in the memory unit, executes the print job when the user authentication is successful, and performs a process of subjecting the print job to the set treatment when the non-printable error is detected during the execution of the print job.

2. The printing apparatus according to claim 1, wherein the treatment for interruption of the print job due to the error is set using the user interface.

3. The printing apparatus according to claim 1, wherein the treatment for interruption of the print job due to the error is preliminarily set in the printing apparatus.

4. The printing apparatus according to claim 1, wherein the treatment for interruption of the print job due to the error is set as a reception result of the print job from the reception unit.

5. The printing apparatus according to claim 1, wherein the control unit is configured to detect lack of consumables of the printing unit as the non-printable error.

6. The printing apparatus according to claim 1, wherein the control unit is configured to request selection whether the print job should be left in the memory unit, as treatment setting for the print job.

7. The printing apparatus according to claim 6, wherein the control unit is configured to request the user to input authentication information after the error is eliminated, and then resume the execution of the print job left in the memory unit.

8. The printing apparatus according to claim 1, wherein the user authentication is performed with reference to at least one of a password, an IC card, and a fingerprint as the authentication information.

9. A printing method comprising:
receiving a print job that requires user authentication;
storing the received print job in a memory unit;
performing the user authentication on the basis of user authentication information input with respect to the print job stored in the memory unit by using a user interface;
executing the print job when the user authentication is successful;
detecting a non-printable error that occurs during execution of the print job stored in the memory unit;
setting treatment of the print job that has been interrupted due to the error; and
performing a process of subjecting the print job to the set treatment when the non-printable error is detected during the execution of the print job.

10. The printing method according to claim 9, wherein the treatment for interruption of the print job due to the error is set using the user interface.

11. The printing method according to claim 9, wherein the treatment for interruption of the print job due to the error is preliminarily set in a printing apparatus.

12. The printing method according to claim 9, wherein the treatment for interruption of the print job due to the error is set as a reception result of the print job from the reception unit.

13. The printing method according to claim 9, further comprising detecting lack of consumables of the printing unit as the non-printable error.

14. The printing method according to claim 9, further comprising requesting selection whether the print job suspended should be left in the memory unit, as treatment setting for the print job.

15. The printing method according to claim 14, further comprising requesting the user to input authentication information after the error is eliminated, and then resuming the execution of the print job left in the memory unit.

16. The printing method according to claim 9, wherein the user authentication is performed with reference to at least one of a password, an IC card, and a fingerprint as the authentication information.

17. A printing system comprising:
a printing apparatus; and
a print request apparatus which transmits a print job that requires user authentication to the printing apparatus via a communication line;
wherein the printing apparatus includes:
a printing unit, a reception unit which receives the print job from the print request apparatus,
a memory unit which stores the print job received by the reception unit,
a user interface which is operated to input authentication information with respect to the print job stored in the memory unit, and
a control unit which detects a non-printable error that occurs in the printing unit during execution of the print job, sets treatment of the print job that has been interrupted due to the error, performs the user authentication on the basis of the authentication information input by using the user interface for the execution of the print job stored in the memory, executes the print job when the user authentication is successful, and performs a process of subjecting the print job to the set treatment when the non-printable error is detected during the execution of the print job.

18. The printing system according to claim 17, wherein the treatment for interruption of the print job due to the error is set using the user interface.

19. The printing apparatus according to claim 17, wherein the treatment for interruption of the print job due to the error is preliminarily set in the printing apparatus.

20. The printing apparatus according to claim 17, wherein the treatment for interruption of the print job due to the error is set as a reception result of the print job from the reception unit.

21. The printing system according to claim 17, wherein the control unit is configured to detect lack of consumables of the printing unit as the non-printable error.

22. The printing system according to claim 17, wherein the control unit is configured to request selection whether the print job should be left in the memory unit, as treatment setting for the print job.

23. The printing system according to claim 22, wherein the control unit is configured to request the user to input authentication information after the error is eliminated, and then resume the execution of the print job left in the memory unit.

24. The printing system according to claim 17, wherein the user authentication is performed with reference to at least one of a password, an IC card, and a fingerprint as the authentication information.

25. The printing system according to claim 17, wherein the printing apparatus are incorporated in a digital multifunction peripheral.

26. The printing system according to claim 25, wherein the print request apparatus is composed of a computer connected to the digital multifunction peripheral by a wire or wireless local area network that functions as the communication line.

27. The printing system according to claim 17, wherein the print request apparatus is configured to add to the print job reference authentication information that is collated with the authentication information input in the user authentication.

28. The printing system according to claim 17, wherein the control unit is configured to collate reference authentication information stored in the memory unit in advance with the authentication information input in the user authentication.

29. The printing system according to claim 17, wherein the user interface includes an authentication machine that reads an IC card or a fingerprint as the authentication information.
